(19) United States
(12) Patent Application Publication
(10) Pub. No.: US 2011/0162781 A1
(43) Pub. Date: Jul. 7, 2011

(54) REMOVABLE DISPLAY PAD FOR MATTRESS FOOT PROTECTORS

(75) Inventors: Kimberly Lynn Grubb, Trinity, NC (US); Garry Wayne Jones, Winston-Salem, NC (US)

(73) Assignee: WRIGHT OF THOMASVILLE, INC., Thomasville, NC (US)

(21) Appl. No.: 13/028,358

(22) Filed: Feb. 16, 2011

Related U.S. Application Data
(63) Continuation-in-part of application No. 12/652,285, filed on Jan. 5, 2010.

(51) Int. Cl. G09F 3/10; B32B 33/00

(52) U.S. Cl. 156/90; 40/638

(57) ABSTRACT

A removable display pad for a foot protector of the mattress that includes a polymeric sheet. An adhesive material is applied to the undersurface of the sheet that permanently adheres to the polymeric sheet, yet releasably attaches the sheet to the foot protector for use on the mattress. The polymeric sheet includes marketing information.

### CROSS-REFERENCE TO RELATED APPLICATIONS

This application is a continuation-in-part of U.S. patent application Ser. No. 12/652,285, filed on Jan. 5, 2010, now pending, the entirety of which is incorporated by reference herein.

### FIELD OF THE INVENTION

The present invention relates to a removable display pad for use with mattress foot protectors in a mattress showroom environment.

### BACKGROUND OF THE INVENTION

Mattresses are sold in retail showrooms. Typically, display mattresses are arranged on the floor so that the prospective purchaser can peruse the various types of mattresses offered by that retailer. In addition to evaluating various promotional materials in the showroom, the prospective buyer might “test” the mattress. This “test” involves lying on the mattress to evaluate softness, firmness or other attributes desirable to the purchaser. Lying on the mattress can result in damage, soiling, wear and tear. Retail showrooms are high traffic areas, and mattresses may be repeatedly tested and damaged.

Foot protectors for mattresses have been used to minimize damage to display mattresses in retail showrooms. Protectors used to date are expensive, cumbersome to place and secure on the mattress, which may unduly damage or compromise the visual appearance of the mattress. Examples are described in U.S. Pat. Nos. 6,845,532; 6,216,292; and 6,014,782.

### SUMMARY OF THE INVENTION

The present invention is directed to a removable display pad that includes a polymeric sheet of an approximate size and shape to cover at least a portion of a fabric foot protector used on the upper surface of a mattress. An adhesive material is applied to the undersurface of the sheet that permanently adheres to the polymeric sheet, yet releasably attaches the sheet to the mattress foot protector without marring of the surface thereof. The polymeric sheet includes marketing information thereon.

The term “foot portion,” as used herein, means the lower inches (10-30 inches) of the upper surface of the mattress where a customer's feet would rest if the customer were to fully lie on the mattress to test the comfort and support. The term “foot protector,” as used herein, means a device used to cover at least part of the foot portion of a mattress. The term “marketing information” refers to any of the following including: advertising materials, sales materials, manufacturer's logos and trademarks, promotional materials or the like, in the form of pictures, and/or any other form of media.

### BRIEF DESCRIPTION OF THE DRAWINGS

FIG. 1 is a perspective view of a removable display pad and foot protector on a mattress.

FIG. 2 is a sectional view of a removable display pad.

### DETAILED DESCRIPTION

Certain exemplary embodiments of the present invention are described below and illustrated in the accompanying figures. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art and all such alternate embodiments, modifications, and improvements are within the scope of the present invention.

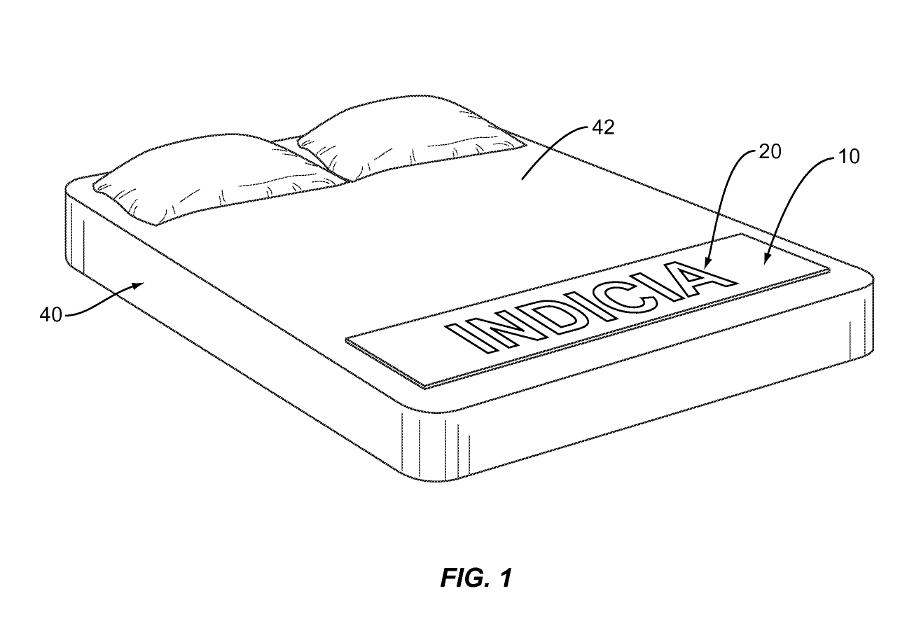

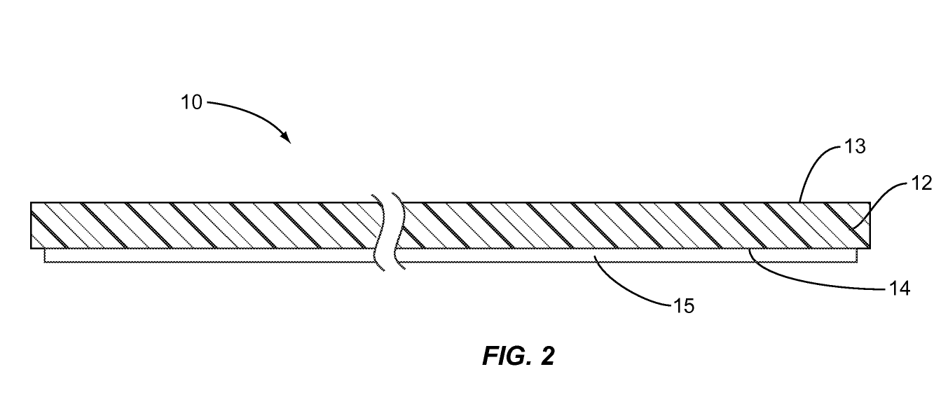

As shown in FIGS. 1 and 2, a removable display pad 10 is releasably attached to a foot protector 30 attached to the mattress 40, such as a display mattress in a retail showroom. The removable display pad 10 includes a polymeric base sheet 12 carrying marketing information 20, a first or protective film 11 in the form of a transparent polymeric overlaminate on top of the base sheet 12, adhesive material 15 on the underside of base sheet 12, and a removable film layer, or liner 16 (illustrated by dashed lines in FIG. 2).

The removable display pad 10 displays marketing information to a customer considering a mattress and is changeable as will be discussed below. Further, the display pad 10 and foot protector 30 minimizes damage, soiling or wear to the mattress when a prospective purchaser is testing the mattress in the showroom. The adhesive material is so selected as to prevent damage to the fabric when the display pad 10 is removed therefrom.

The releasability of the pad 10 allows a sales associate to easily change the marketing information 20 viewable by a prospective purchaser as needed. For example, as mattress products in the showroom change, or marketing programs change, a new display pad 10 may be used on the mattress foot protector. To accomplish this, all that is necessary is to remove the peel off liner, protective layer, or film 16 from the adhesive material 15 and place the display pad 10 on the desired foot protector.

Referring again to FIG. 1, the display pad 10 is used on a foot protector 30 secured to a mattress 40. The display pad 10 may be used with any type of foot protector 30. Further, the particular foot protector 30 may be formed of any textile material including, but not limited to, woven, knit, non-woven, or any other material, or combination of materials suitable for use as a foot protector. In a preferred embodiment, the foot protector 30 is a fabric type foot protector. The foot protector 30 may have a decorative hem or other stitching along its perimeter to minimize fraying and to also provide a design effect. The foot protector 30 may also include an embroidered image, design, logo or other design effect. The foot protector 30 is shown having a length at least as wide as the mattress 40 so that ends of the foot protector 30 may be tucked under the mattress 40 to secure the protector thereto. In other embodiments, the foot protector 30 includes a mechanical fastener and/or cordage to secure the foot protector 30 to the mattress 40. In still other embodiments, the ends of the foot protector may include tassels and the like.

The removable pad 10 and foot protector 30 may be used on any type of mattress. For example, twin, twin XL, full, queen, king, the “California king,” are exemplary sized mattresses. The pad 10 may be sized to substantially cover a foot protector used on a conventional mattress design or other mattress shapes and sizes that may be developed. The pad 10 may be used on any mattress including, but not limited to, innerspring, foam (viscoelastic and/or latex), air, futons, and waterbeds. Mattress ticking, as used herein, refers to decorative woven or knit fabrics, or any other materials, that is the outer surface of the mattress.

As shown in FIG. 2, the removable display pad 10 includes the polymeric base sheet 12 having top and bottom surfaces 13 and 14, respectively. The polymeric base sheet 12 may be flexible to conform to the outer surface 42 of the mattress 40 or it may be a stiffer material. In other alternate embodiments, the polymeric sheet 12 may be malleable. An exemplary polymeric sheet 12 is polyvinyl chloride (PVC). In other alternate embodiments, however, the polymeric sheet 12 may be polyethylene terepthalate (PET), polyethylene (PE) or polypropylene (PP). An exemplary polymeric sheet 12 has a thickness between about 2.0 and about 5.0 mils, preferably about 3.7 mils.

The first or protective film (or overlaminate) 11 may be any transparent polymeric film for protecting the top surface 13 of the base sheet 12. The overlaminate 11 also includes an adhesive for permanent attachment to the polymeric sheet 12. Alternatively, the overlaminate may be applied by heat and pressure, or any other technique, to the base sheet 12. Exemplary overlaminates include, but are not limited to, polyvinyl chloride (PVC), polyethylene terepthalate (PEI), polyethylene (PE) or polypropylene (PP).

Marketing information 20 is included on the upper surface of the display pad 10 for viewing by a prospective customer. The overlaminate 11 is affixed to the top surface of polymeric sheet 12 to protect the marketing information 20. The marketing information 20 is printed or otherwise applied directly to the polymeric sheet 12. In an exemplary embodiment, the marketing information 20 is printed on the sheet 12 with solvent/UV based ink jet media. In other embodiments, the ink jet media may be water based. In other embodiments, the marketing information may be printed with any suitable types of inks and/or pigments. In alternate embodiments, the marketing information is integrally formed with the polymeric sheet 12. For example, a logo or trademark may be formed in the polymeric sheet 12 during manufacture. In other embodiments, the marketing information may be printed onto a separate sheet, film or material, that is then applied to the polymeric sheet 12 using any suitable adhesive.

As shown in FIG. 2, a pressure sensitive adhesive material 15 is applied to the bottom surface 14 of the polymeric sheet 12. A second, removeable, peel-off liner or film 16 is applied and protects the adhesive material 15 prior to its emplacement on the mattress 40. The second film or liner 16 is removable and is discarded upon removal from the display pad 10.

The adhesive material 15 releasably attaches the display pad 10 to the mattress 40. In a preferred embodiment, the adhesive material 15 is permanently affixed to the polymeric sheet 12 while allowing for the releasable attachment of the display pad 10 to the outer surface 42 of the foot protector 30. The adhesive material is selected to prevent damage, e.g., marring of the fabric or pattern, abrasion, etc., to the foot protector 30, which might otherwise occur when removing an adhesive from the foot protector 30.

The adhesive material is a chemical, polymer, copolymer, polymer or co-polymer blend, a composition, resin, or any combination thereof, that forms a temporary bond with the foot protector. An exemplary adhesive material is an acrylic pressure sensitive adhesive. As used herein, a “pressure sensitive adhesive” refers to an adhesive that forms a temporary bond upon the application of pressure. In other alternate embodiments, however, a non-pressure sensitive adhesive is used.

The adhesive material may be a natural or synthetic adhesive. Exemplary natural adhesives include, but are not limited to, starch, animal or vegetable resins. Exemplary synthetic adhesives include, but are not limited to, acrylic and/or other acrylate based adhesives, rubber based adhesives, polyvinyl acetate, epoxy, or polyurethane. In a preferred embodiment, the adhesive material is acrylic based.

The adhesive material 15 is applied to the polymeric sheet 12 with a liquid carrier, or in solid form. Preferably the adhesive material is a liquid carrier or solvent based adhesive. For liquid carrier adhesives, the adhesive is coated onto the polymeric sheet 12, and the solvent, or water carrier is dried off. Additional heat may be applied to the adhesive and polymeric sheet 12 to initiate a cross-linking reaction and increase molecular weight of the adhesive. The solid adhesives may be low viscosity polymers. The solid adhesive materials are also coated onto the polymeric sheet 12 and reacted with radiation to increase molecular weight and form the adhesive thereon. In other embodiments, the solid-type adhesives may be high viscosity materials that are heated to reduce viscosity enough to allow coating, and then cooled to their final form on the polymeric sheet 12.

### EXAMPLE A

In one example of the invention, the removable display pad 10 includes a polyvinyl chloride sheet 12 with an acrylic based, pressure sensitive adhesive 15 applied thereto. A peel off liner is included on the adhesive material, and is discarded prior to application on the mattress. An exemplary product is product no. JTS828 HTO, available under the Mac Tac® brand (A Bemis Company). This product is a 3.7 mil matte white, soft calendared PVC film coated on one side with a high tack, permanent, opaque, solvent acrylic pressure sensitive adhesive, supplied with a Kraft liner. Marketing information may be printed thereon using solvent-based ink jet printing media. A vinyl overlaminate, such as Print Shield® SEAL®, available from Neschen Americas, Inc, is used to protect the marketing information.

### EXAMPLE B

In another example of the invention, the removable display pad 10 includes a polyvinyl chloride sheet 12 with an acrylic based, pressure sensitive adhesive 15 applied thereto as described above. The removable display pad is placed on a fabric foot protector, for example, Style 12081 Foot Protector with Flange and polyester backing, available from Wright Graphics.

Although the present invention has been described with exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed is:

1. A removable display pad for a mattress foot protector for mattresses on display in a showroom, wherein the pad is releasably attached to a foot protector, the removable display pad presenting marketing information regarding protecting the mattress from customer soiling, wear and damage when testing the mattress in the showroom comprising:
a. a polymeric sheet of such size and shape as to, when applied to the foot protector on the mattress, substantially covers the portion of the foot protector on the upper surface of the mattress, the sheet having a top surface and an undersurface;
b. the polymeric sheet having marketing information visible on the top surface of the sheet;
c. an adhesive material on the undersurface of the sheet, the adhesive being releasably attachable to the surface of the foot protector without marring the surface thereof.

2. The removable display pad of claim 1, wherein the adhesive material is a pressure sensitive adhesive.

3. The removable display pad of claim 1, further comprising a transparent film affixed to the top surface of the polymeric sheet to protect the marketing information thereon.

4. The removable display pad of claim 1, wherein the polymeric sheet is selected from the group consisting of a polyvinyl chloride, polyethylene, polypropylene, and polyethylene terepthalate.

5. The removable display pad of claim 1, further comprising a removable liner on the adhesive material.

6. The method for protecting a mattress in a showroom while also displaying marketing information, the method comprising:
a. providing a mattress;
b. providing a fabric foot protector and placing the foot protector on the foot portion of the mattress;
c. providing a removable display pad, the removable display pad comprising:
i. a polymeric sheet of such size and shape as to, when applied to the mattress, substantially cover the foot protector of the mattress, the sheet having a top surface and an undersurface;
ii. the polymeric sheet having marketing information visible on the top surface of the sheet;
iii. an adhesive material on to the undersurface of the sheet, the adhesive being releasably attachable to the surface of the foot protector without marring the decorative surface thereof.
d. removeably attaching the removable display pad to the foot protector.

7. The method of claim 6, the method further comprising removing the removable display pad and replacing the removable display pad with another removable display pad having different marketing information.

8. The method of claim 6, wherein the adhesive material is a pressure sensitive adhesive.

9. The method of claim 6, wherein the removable display pad further comprises a transparent film affixed to the top surface of the polymeric sheet to protect the marketing information thereon.

10. The method of claim 6, wherein the polymeric sheet is selected from the group consisting of a polyvinyl chloride, polyethylene, polypropylene, and polyethylene terepthalate.

11. The method of claim 6, wherein the removable display pad further comprises a removable liner on the adhesive material.

12. The method of claim 11, further comprising removing the removable liner from the adhesive material.
